(19) United States
(12) Patent Application Publication
(10) Pub. No.: US 2007/0239456 A1
(43) Pub. Date: Oct. 11, 2007

(54) Audio accessibility enhancement for computer audio events

(75) Inventors: Brian D. Goodman, Norwalk, CT (US); Frank L. Jania, Chapel Hill, NC (US); Darren M. Shaw, Hampshire (GB)

Correspondence Address: HARRINGTON & SMITH, PC, 4 RESEARCH DRIVE, SHELTON, CT, 06484-6212, US

(73) Assignee: International Business Machines Corporation

(21) Appl. No.: 11/399,830

(22) Filed: Apr. 7, 2006

(51) Int. Cl. G10L 21/00

(52) U.S. Cl. 704/270

(57) ABSTRACT

A computer program product is presented including program instructions embodied on a tangible computer-readable medium. Execution of the program instructions results in operations including: monitoring at least one pathway between at least one application and a sound device in order to detect a presence of data that represents an audio signal; and in response to detecting the presence of data, generating a visual notification corresponding to the audio signal.

### TECHNICAL FIELD

The teachings in accordance with the exemplary embodiments of this invention relate generally to computer systems and software and, more specifically, relate to sound management in computer systems and software.

### BACKGROUND OF THE INVENTION

Audio is commonly used in conventional computer systems and software as a means of alerting a user to a system or software event. Non-limiting examples of these events include system errors and e-mail and chat notifications.

An exemplary way for a computer application to play a sound is by sending a message using an Application Programming Interface (“API”). An API is a part of an Operating System (“OS” or “OSs” in the plural) that defines a language and/or message format by which an application can communicate with the OS. For instance, the message might be “play (sound.wav)”, where sound.wav is a “wave” file stored in a particular location on the electronic device. The “sound.wav” is a file of information having sound data. The “play (.)” is a function supported by an API in the OS.

The API is a part of the OS and, in this example, the play (.) function performs all necessary operations so that the computer software is properly coupled to an Audio/Video (A/V) component, such as a sound card, enabling the sound file to be played on a sound device, such as a speaker. Generally, an A/V component has a number of Multimedia (MM) devices. For instance, a wavetable synthesizer might be used to play information from the sound.wav file. In general, one or more drivers are intermediate the API and the A/V component. The drivers are typically installed into and become part of the OS. The drivers are designed to interface with the OS and to operate, at a low level, the MM devices on the A/V component. The API function play (.) fetches data from the wave file at appropriate times, possibly fills buffers, and ensures that the wave file is doled out to the driver(s) at the correct times. The play (.) function can, in this example, also message the application when the wave is done playing. Thus, the OS of an electronic device can provide techniques useful for playing sounds.

Some computer systems and software provide additional accessibility for users with hearing impairment or for users in an audio-free environment. This additional accessibility may take the form of a visual means for alerting the user that an audio event has occurred. FIG. 1 shows a Sound tab 100 of an Accessibility Options dialogue 101 for a Windows XP® OS wherein a user can activate SoundSentry and ShowSounds. SoundSentry has Windows XP® generate a visual warning when the system makes a sound. The Accessibility Options dialogue 101 also allows a user to activate ShowSounds. ShowSounds tells compatible programs to show captions for the speech and sounds produced by the programs.

### SUMMARY

In an exemplary aspect of the invention, a computer program product is presented including program instructions embodied on a tangible computer-readable medium. Execution of the program instructions results in operations including: monitoring at least one pathway between at least one application and a sound device in order to detect a presence of data that represents an audio signal; and in response to detecting the presence of data, generating a visual notification corresponding to the audio signal.

In another exemplary aspect of the invention, a method is provided. The method includes: monitoring at least one pathway between at least one application and a sound device in order to detect a presence of data that represents an audio signal; and in response to detecting the presence of data, generating a visual notification corresponding to the audio signal.

In a further exemplary aspect of the invention, an electronic device is provided. The electronic device includes: at least one memory; and at least one data processor coupled to the at least one memory. The at least one data processor is operable to perform operations including: monitoring at least one pathway between at least one application and a sound device in order to detect a presence of data that represents an audio signal; and in response to detecting the presence of data, generating a visual notification corresponding to the audio signal.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows a Sound tab of an Accessibility Options dialogue for a Windows XP® OS wherein a user can activate SoundSentry and ShowSounds;

FIG. 2 depicts a portion of an OS desktop that incorporates aspects of the invention;

FIG. 3 shows a portion of an OS desktop illustrating an alternate embodiment of the invention;

FIG. 4 shows a portion of an OS desktop illustrating another embodiment of the invention;

FIG. 5 shows a portion of an OS desktop illustrating an alternate embodiment of the invention;

FIG. 6 illustrates a simplified block diagram of an electronic device that is suitable for use in practicing the exemplary embodiments of this invention;

FIG. 7 depicts a flowchart illustrating one non-limiting example of a method for practicing the exemplary embodiments of this invention;

FIG. 8 shows an exemplary block diagram illustrating a portion of the potential software and hardware structure in the electronic device of FIG. 6;

FIG. 9 shows a flowchart illustrating one non-limiting example of a method for practicing the exemplary embodiment of FIG. 8; and

FIG. 10 shows another exemplary block diagram illustrating potential software and hardware structure in the electronic device of FIG. 6.

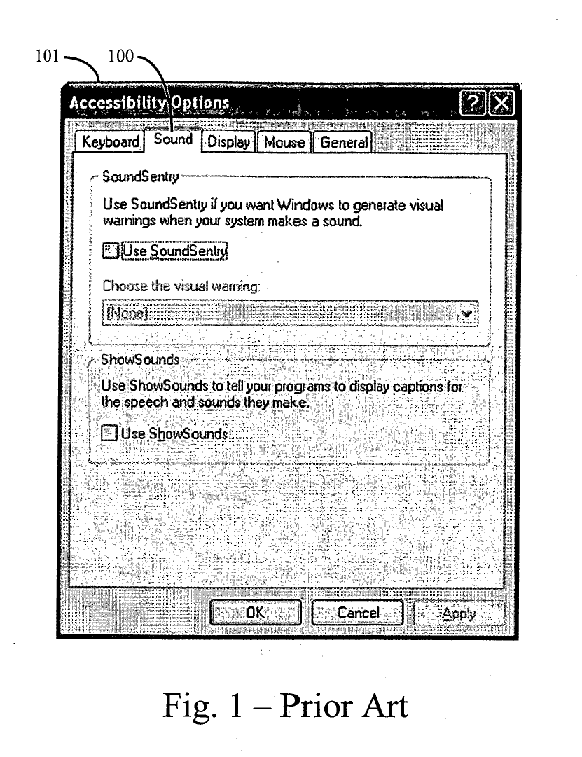

### DETAILED DESCRIPTION

Not all conventional systems and software provide additional functionality that enables accessibility for users with hearing impairment or for users in an audio-free environment. Although some OSs provide an API for facilitating such accessibility (e.g. Windows XP®), not all software programs adhere to or make use of the accessibility API. In addition, the accessibility API only applies to audio associated with system events. As a non-limiting example, if a user is using an application that may play an unexpected audio stream, such as a Flash movie in a web browser, the accessibility API will not indicate that there is audio being played.

It would therefore be desirable to provide techniques that enable accessibility for users with, for example, hearing impairment or for users in an audio-free environment regardless of whether an accessibility API is available, whether a particular computer program utilizes an available accessibility API, or whether the audio is associated with a system event. Exemplary embodiments of the invention provide such techniques by monitoring a pathway between an application and a sound device in order to detect a presence of data that represents an audio signal as opposed to relying on one or more accessibility APIs provided by an OS. In response to the detection of the presence of data, exemplary embodiments of the invention generate a visual notification corresponding to the audio signal.

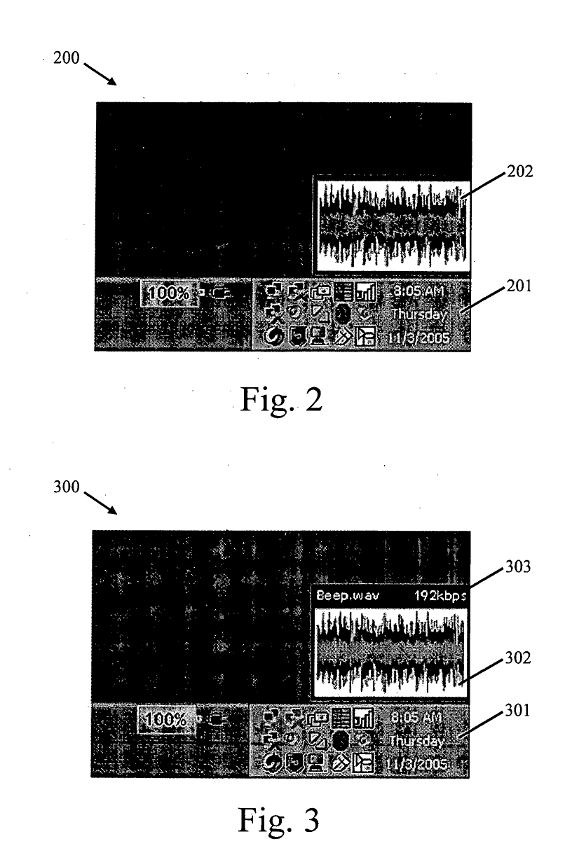

Referring to FIG. 2, a portion of an OS desktop 200 is shown that incorporates aspects of the invention. In the exemplary embodiment of FIG. 2, the OS is a Windows OS. In other exemplary embodiments, the invention may be coupled to a different OS. In further exemplary embodiments, the invention may be employed in conjunction with an entity other than an OS.

The desktop portion 200 shown in FIG. 2 is the lower right corner of the desktop, wherein a systray 201 is usually located. Above the systray 201, an audio notification window 202 is shown that incorporates aspects of the invention. The audio notification window 202 appears in response to the invention detecting the presence of data representing an audio signal in the computer system as further explained below with respect to FIGS. 7-10. In the audio notification window 202 of FIG. 2, such data has been detected and a waveform depiction of the audio signal is shown to notify a user of the positive detection.

Alternate embodiments of the invention may have the audio notification window 202 open and visible on the desktop prior to the detection of data representing an audio signal. In such an exemplary embodiment, in response to the data being detected the graphic shown in the audio notification window 202 would change to reflect the positive detection. In other embodiments of the invention, the audio notification window 201 may be located elsewhere on the desktop, including the systray 201 and the programs region of a taskbar, as non-limiting examples. In further alternate embodiments, the audio notification window 202 may not in fact be a separate window. As a non-limiting example, the function of the audio notification window 201 could be incorporated into an icon located in the systray 201. In response to data representing an audio signal being detected, the icon in the systray could flash red, thus alerting a user that such data has been detected.

Referring to FIG. 3, a portion of an OS desktop 300 is shown illustrating an alternate embodiment of the invention. Above a systray 301, an audio notification window 302 is visible displaying a waveform corresponding to a detected audio signal. The audio notification window 302 has appeared in response to the detection of data representing an audio signal in the computer system in accordance with aspects of the invention. In contrast to the audio notification window 202 of FIG. 2, the audio notification window 302 of FIG. 3 presents additional information 303 about the corresponding audio signal. In this example, the audio signal is an audio file named “Beep.wav.” In addition, a sampling rate of the Beep.wav audio file, 192 kbps, is displayed. The sampling rate of the audio file can be determined by employing techniques known in the arts.

The name of the audio file whose data is detected may be determined by employing a correlation method. As a non-limiting example, the correlation method may consist of comparing an audio signal associated with the detected audio data and/or transmitted audio file with audio signal information of every audio file on the system. This exemplary correlation method may correlate the audio signal based on a point-by-point comparison, an every-thousandth-point comparison, or a hash function (e.g. a known hash function such as MD5), as non-limiting examples. If using a hash function, a digital signal would simply be hashed while an analog signal would be converted to a digital representation. As a non-limiting example of such an analog-to-digital conversion, the analog signal could be sampled to become digital. In converting an analog signal, and as a non-limiting example, the data could be hashed as it is converted to digital. In a preferred embodiment of such an exemplary correlation method, a hash function would be utilized and applied to the digital contents or digitized contents. In such a manner, the detected data may be correlated with a known audio file in the system and the name of the audio file represented by the detected data can be displayed in the additional information 303 of the audio notification window 302.

Although the correlation method may be utilized in real time, immediately after data representing an audio signal is detected by embodiments of the invention, in a preferred embodiment a library is utilized in conjunction with the correlation method. The library is a collection of information gathered and assembled prior to the detection of data representing an audio signal that enables embodiments of the invention to more readily correlate detected data with known audio files on the system. In a non-limiting example of an embodiment of the invention utilizing a library in conjunction with a correlation method, the library contains sampling rate information associated with the name of audio files on the system. Thus, when such an embodiment detects data representing an audio signal, the invention need only ascertain the sampling rate of the audio signal and compare it against the library. The name of the audio file producing the audio signal can readily be obtained and displayed in such a manner. In an additional non-limiting example, instead of or in addition to utilizing the sampling rate of the audio signal in conjunction with a correlation method, the waveform of the audio signal may be utilized.

Alternate embodiments of the invention may collect and/or display different or additional information concerning the data representing an audio signal and/or the associated audio file and/or audio signal. As a non-limiting example, the program source of the audio signal, if any, may be indicated. In other embodiments, and as an additional non-limiting example, different or additional information may be collected and/or displayed by the audio driver being rewritten to capture more data about the audio signal and offering a tap for that information. In alternate embodiments of the invention, the visual element of the additional information may vary. As a non-limiting example, different fonts, colors, or symbols may be employed. As an additional non-limiting example, graphics may be utilized as opposed to textual descriptions.

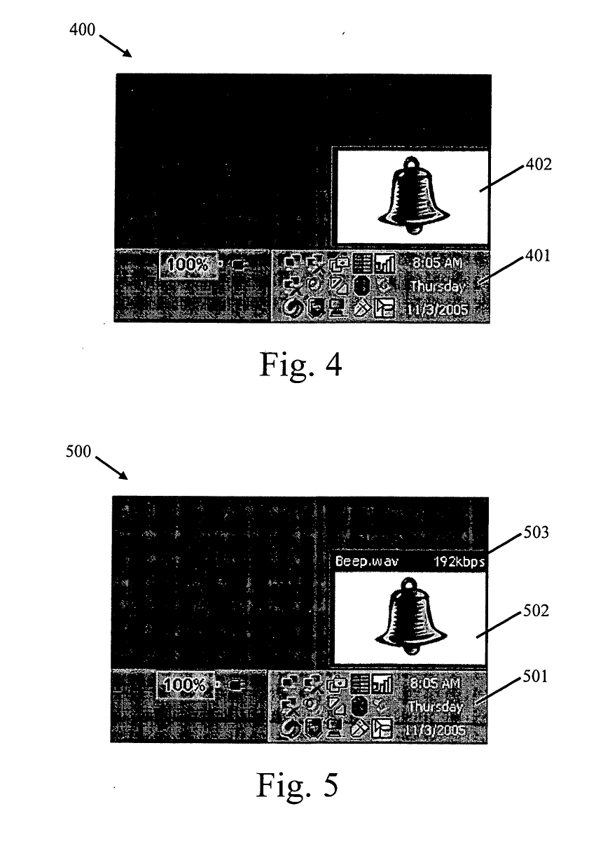

Referring to FIG. 4, a portion of an OS desktop 400 is shown illustrating another embodiment of the invention. Above a systray 401, an audio notification window 402 is visible. The audio notification window 402 has appeared in response to the detection of data representing an audio signal in the computer system in accordance with aspects of the invention. In contrast to the audio notification windows 202 and 302 of FIGS. 2 and 3, the audio notification window 402 of FIG. 4 displays a bell graphic (a picture of a bell) representing the audio signal. The bell graphic in the audio notification window 402 of FIG. 4 is displayed since a user previously associated the bell graphic with a specific audio signal (e.g. waveform) or audio file (e.g. Beep.wav).

Referring to FIG. 5, a portion of an OS desktop 500 is shown illustrating an alternate embodiment of the invention. Above a systray 501, an audio notification window 502 is visible displaying a bell graphic representing an audio signal. The audio notification window 502 has appeared in response to the detection of data representing an audio signal in the computer system in accordance with aspects of the invention. Similar to the audio notification window 302 of FIG. 3, the audio notification window 502 of FIG. 5 presents additional information 503 about the audio signal. Also as in FIG. 3, and as visible in the additional information 503 of FIG. 5, the audio signal is produced by an audio file named “Beep.wav.” and has a sampling rate of 192 kbps.

In other embodiments, if the name of the audio file producing the audio signal cannot be determined, the audio notification window may show a waveform depiction instead of an associated graphic.

Although shown in FIGS. 2 and 3 as a waveform and in FIGS. 4 and 5 as a bell graphic, in other exemplary embodiments the visual notification element of the audio notification window may incorporate different visual notifications, including different graphics and/or textual elements as non-limiting examples. As a non-limiting example, the visual notification could consist of the word “BEEP” being displayed in response to the positive detection of data representing “Beep.wav.” In addition, although referred to herein as an audio notification window, in alternate embodiments the audio notification window does not necessarily comprise a “window.” In such alternate embodiments, the audio notification window could comprise a word or picture flashing on the screen independent of any window elements, as a non-limiting example. As an additional non-limiting example, and as noted above in discussing FIG. 2, the audio notification window could comprise an icon in the systray.

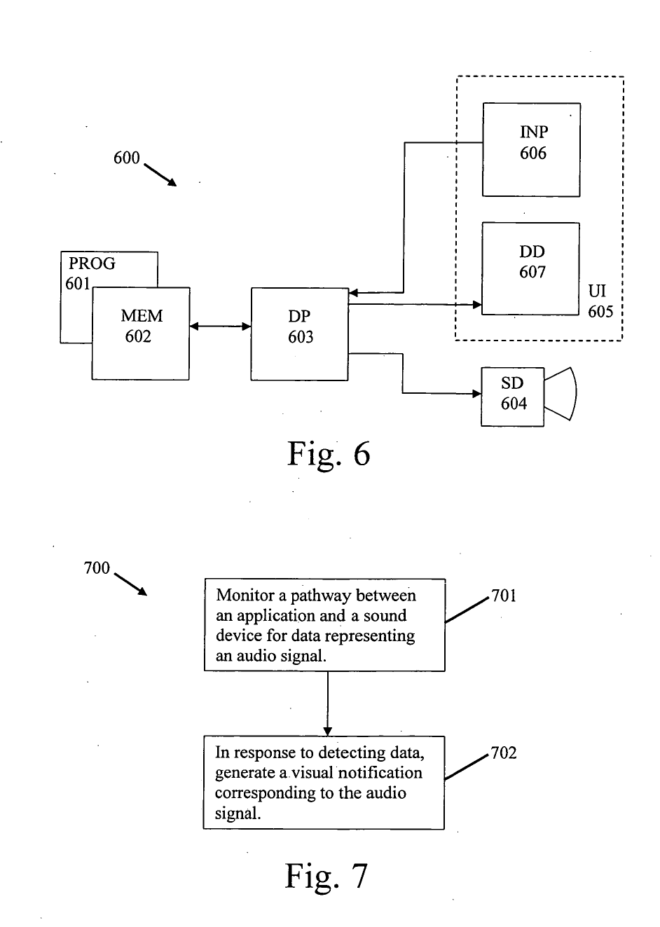

Reference is made to FIG. 6 for illustrating a simplified block diagram of an electronic device 600, such as a computer, that is suitable for use in practicing the exemplary embodiments of this invention. In FIG. 6, the electronic device 600 includes a memory (MEM) 602 that stores program code (PROG) 601, a data processor (DP) 603 coupled to the MEM 602, at least one sound device (SD) 604 coupled to the DP 603, and a user interface (UI) 605 comprising at least one input device (INP) 606 and at least one display device (DD) 607, the UI being coupled to the DP 603. The SD 604 is any device enabled to produce audible sound. A non-limiting example of a SD 604 is a speaker or any other type of device that transduces electrical energy to acoustic energy. The PROG 601 is assumed to include program instructions that, when executed by the DP 603, enable the electronic device 600 to operate in accordance with the exemplary embodiments of this invention, as discussed herein. The PROG 601 may be part of an OS (not shown in FIG. 6) or separate from an OS.

An “electronic device” is any powered (e.g., though alternating current, direct current, and/or battery) apparatus having a processing unit such as a data processor, microprocessor, digital signal processor, or other comparable component and one or more memories (e.g., internal and/or external to the processing unit). Typically, the processing unit will be a general purpose processor, and the processor will contain internal memory and have access to external memory. Exemplary electronic devices include computers, cellular phones, portable computers, and personal digital assistants, as non-limiting examples.

Exemplary embodiments of the invention can take the form of an entirely hardware embodiment, an entirely software embodiment or an embodiment containing both hardware and software elements. In a typical embodiment, the invention is implemented in software, which includes but is not limited to firmware, resident software and/or microcode, as non-limiting examples.

Furthermore, exemplary embodiments of the invention can take the form of a computer program product accessible from a computer-useable or computer-readable medium providing program code for use by or in connection with a computer or any instruction execution system. For the purposes of this description, a computer-useable or computer-readable medium can be any apparatus that can contain, store, communicate, propagate, or transport the program for use by or in connection with the instruction execution system, apparatus, or device.

The medium can be electronic, magnetic, optical, electromagnetic, infrared, a semiconductor system (or apparatus or device) or a propagation medium, as non-limiting examples. Non-limiting examples of a computer-readable medium include a semiconductor or solid state memory, magnetic tape, a removable computer diskette, a random access memory (RAM), a read-only memory (ROM), a rigid magnetic disk and an optical disk. Current, non-limiting examples of optical disks include compact disk—read only memory (CR-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or indirectly through intervening I/O controllers.

Network adapters may also be coupled to the system to enable the data processing system to become coupled to other data processing systems or remote printers or storage devices through intervening private or public networks. Modems, cable modem and Ethernet cards are just a few non-limiting examples of the currently available types of network adapters.

FIG. 7 depicts a flowchart illustrating one non-limiting example of a method 700 for practicing the exemplary embodiments of this invention. The method 700 of FIG. 7 could be performed by the PROG 601 of FIG. 6, as a non-limiting example. The method 700 enables accessibility for users with hearing impairment or for users in an audio-free environment. The method 700 of FIG. 7 includes the following steps. In box 701, a pathway between an application and a sound device is monitored for data representing an audio signal. In box 702, in response to the detection of data representing an audio signal, a visual notification corresponding to the audio signal is generated.

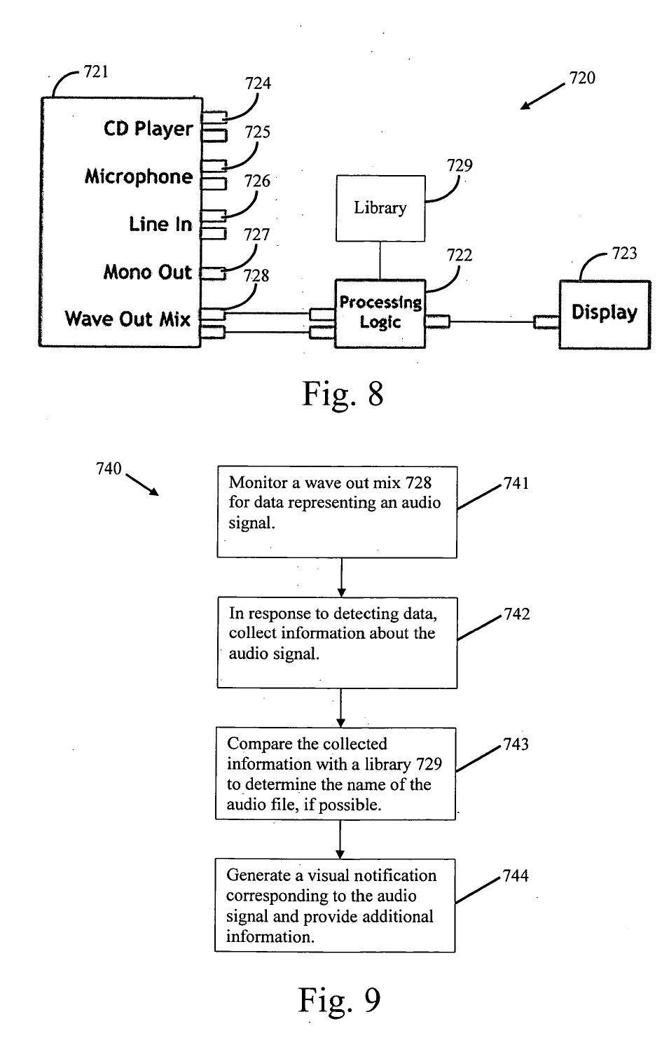

The monitoring that the method 700 of FIG. 7 performs in box 701 may be accomplished by techniques known in the art. As a non-limiting example, APIs of the OS may be utilized to detect the use of a wave out mix device driver in conjunction with data representing an audio signal, as employed in the embodiment of FIGS. 8 and 9. Typically, the wave out mix is the default sound output for an OS. As an additional non-limiting example, APIs of the OS may be utilized to detect the use of other device drivers in conjunction with data representing an audio signal, such as a microphone device driver or a line in device driver, as non-limiting examples. In other embodiments, APIs for more than one device driver may be utilized such that more than one device driver is monitored. In alternate embodiments, mechanisms other than APIs may be employed to monitor a pathway between an application and a sound device. In other embodiments, more than one pathway may be monitored. In alternate embodiments, more than one pathway between a plurality of applications and at least one sound device may be monitored.

The pathway between an application and a sound device that is monitored by the method 700 of FIG. 7 may include the monitoring of APIs, device drivers, intermediate applications, audio components, aspects of the OS or other elements in the computer system that are related to sound management, sound production or audio data transmission in the computer system.

Referring to FIG. 8, an exemplary block diagram is shown illustrating a portion of the potential software and hardware structure in the electronic device 600 of FIG. 6. In FIG. 8, portions of both exemplary software and hardware structures are shown. In this example, the electronic device 720 includes audio device drivers 721, processing logic 722 coupled to the audio device drivers 721, a display 723 coupled to the processing logic 722, and a library 729 coupled to the processing logic 722. The audio device drivers 721 include a plurality of device drivers: a Compact Disk (CD) player device driver 724, a microphone device driver 725, a line in device driver 726, a mono out device driver 727, and a wave out mix device driver 728. In the exemplary embodiment of FIG. 8, the processing logic 722 monitors the wave out mix 728 to detect data representing audio signals. In response to detecting such data, the processing logic 722 collects information about the audio signal, applies a correlation method in conjunction with the library 729, presents additional information about the audio signal including the name of the audio file if the name can be determined, generates a visual notification corresponding to the audio signal and displays the visual notification on the display 723. The method illustrated in FIG. 9, and the discussion thereof, further clarifies the course of action of the processing logic 722.

Referring also to FIG. 9, a flowchart is shown illustrating one non-limiting example of a method 740 for practicing the exemplary embodiment of FIG. 8. The method 740 includes the following steps. In box 741, the processing logic 722 monitors a wave out mix 728 for data representing an audio signal. In this example, the monitoring is accomplished using APIs provided by the OS. In alternate embodiments, the monitoring may be accomplished utilizing mechanisms other than OS-provided APIs. In box 742, in response to detecting data representing an audio signal, the processing logic 722 collects information about the audio signal. The information collected includes a hash of the digital contents or digitized contents of the audio signal. As noted above in discussing FIG. 3, in alternate embodiments the information collected may include different information. In box 743, the processing logic 722 compares the collected information with a library 729. The library 729 includes known information about all of the audio files in the system, namely an association of hashed audio signals of the audio files with the names of the audio files. If the collected information matches to one in the library 729, the name of the audio file having that hashed digital content is determined and associated with the audio signal. If a corresponding match cannot be found in the library 729, the processing logic 722 does not associate an audio file name with the audio signal. As noted above in discussing FIG. 3, in alternate embodiments the library 729 may include different information. In box 744, the processing logic 722 generates a visual notification corresponding to the audio signal and provides additional information, in the visual notification, about the audio signal and/or audio file. In the exemplary method 740 of FIG. 9, the additional information includes the sampling rate of the audio signal and the name of the corresponding audio file if a corresponding audio file has been identified and associated with the detected audio signal in box 743. In other embodiments, and as mentioned above, if an audio file name cannot be associated with the audio signal, the processing logic 722 may not show an audio file name in the visual notification. In alternate embodiments, if an audio file name cannot be associated with the audio signal, the processing logic 722 may show a waveform instead of a corresponding graphic, if a corresponding graphic would have been shown upon successful association of an audio file with the audio signal.

Although the exemplary embodiments shown in FIGS. 8 and 9 monitor the wave out mix 728 of the audio device drivers 721, other embodiments of the processing logic 722 may monitor other device drivers in the audio device drivers 721 or other parts of the system.

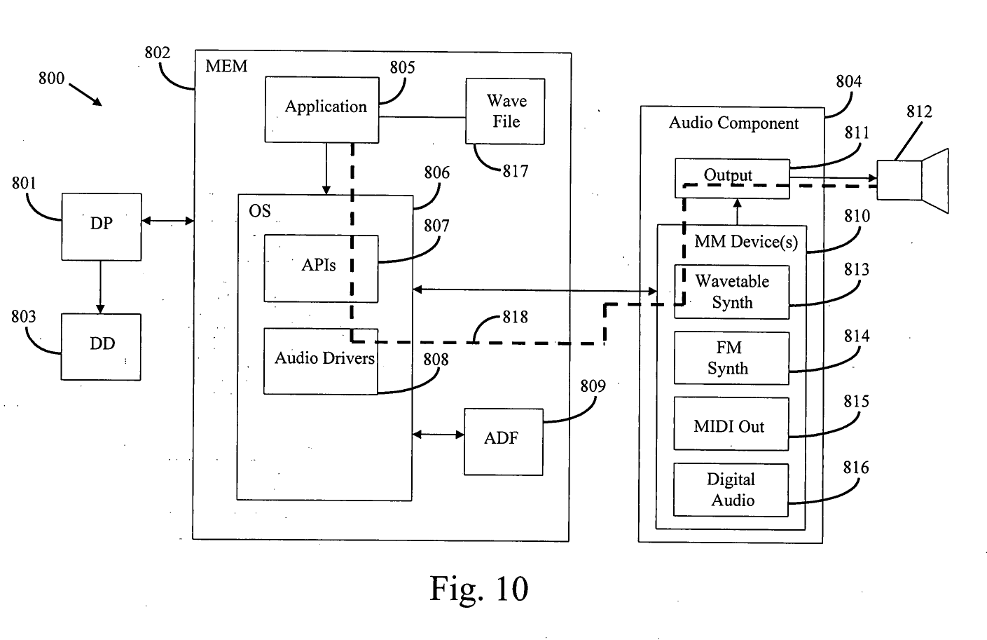

FIG. 10 shows another exemplary block diagram illustrating potential software and hardware structure in the electronic device 600 of FIG. 6. In FIG. 10, both exemplary software and hardware structures are shown. Note that the user interface (UI) 605 and at least one input device (INP) 606 of FIG. 6 are not shown in FIG. 10.

In this example, the electronic device 800 includes a data processor (DP) 801 (e.g., a DP 603 of FIG. 6) coupled to a memory (MEM) 802, a display device (DD) 803 and an audio component 804. The coupling (e.g., typically address, control, and data buses) between the DP 801 and the audio component 804 is not shown for clarity. The electronic device 800 also includes a sound device 812. The MEM 802 includes an application 805 coupled to an operating system (OS) 806. In this example, the application 805 is playing a wave file 817. The OS 806 includes Application Programming Interfaces (APIs) 807 and audio drivers 808. The MEM 802 further includes an audio display function (ADF) 809.

The MEM 802 is read-only memory, read-write memory, or some combination thereof. The MEM 802 can include multiple modules and can include both short-term memories (e.g., random access memories) and long-term memories (e.g., hard drives, compact disk drives). Although one application 805 is shown in FIG. 10, more than one application may be present in the MEM 802.

In this example, the audio component 804 is a hardware component that is assigned one or more addresses from the address space addressable by the DP 801. Although one audio component 804 is shown, electronic device 800 could contain more than one audio component 804. The Multimedia (MM) device(s) 810 are shown as being implemented on the audio component 804. A portion of one or more of the MM device(s) 810 may also be implemented in MEM 802 or one or more of the MM device(s) 810 could be completely implemented in MEM 802. For instance, certain audio codecs (compression-decompression programs) can be implemented in MEM 802 and, e.g., pass data to the digital audio 816. It should also be noted that a current trend is toward adding multimedia functionality into data processors, and therefore some or all of the MM device(s) 810 might be incorporated into the DP 801.

The audio component 804 comprises Multimedia (MM) device(s) 810 and an output 811. The output 811 is connected to the sound device 812 (e.g., speaker or speaker amplifier and speaker). The audio component 810 is a sound card in this example but could be any apparatus able to convert data into analog or digital output suitable for output on a sound device. The MM device(s) 810 comprises a wavetable synthesizer (synth) 813, frequency modulation (FM) synth 814, MIDI out 815, and digital audio 816. Each of the MM device(s) 810 is a device suitable for outputting data to the sound device 812. The wavetable synth 813 is a MM device that uses wave tables to play sounds and can be used for repetitive sounds such as those that occur in games. The FM synth 814 is another MM device for generating sounds through FM. MIDI out 815 is a Music Instrument Digital Interface (MIDI) device, typically used for longer, more musical sounds. The digital audio 816 is a MM device used to play digital sounds, such as wave files. The digital audio 816 will typically contain a Digital to Audio Converter (DAC) (not shown), although the output 811 or even the sound device 812 could contain a DAC. Although shown in FIG. 10 with four devices 813, 814, 815, 816, the specific devices of the MM device(s) 810 are by way of non-limiting examples. Non-limiting examples of additional devices include sound input devices (e.g., a microphone, a line-in, a CD player or a Digital Versatile Disk (DVD) player).

As shown in FIG. 10, the ADF 809 is designed to detect data representing audio signals that is passed along a pathway 818 that extends from the application 805 to the sound device 812. Since the application 805 is playing the wave file 817, audio data representing an audio signal of the wave file will traverse the pathway 818, utilizing the APIs 807, audio drivers 808, wavetable synth 813, output 811 and sound device 812. In response to detecting the audio data, the ADF 809 generates a visual notification corresponding to the audio signal. The visual notification is shown on the DD 803 in accordance with aspects of the invention. The ADF 809 could be performed by the PROG 601 of FIG. 6, as a non-limiting example. The detection of data representing audio signals may be accomplished by utilizing the APIs 807 provided by the OS 806, as a non-limiting example. Although shown in FIG. 10 as monitoring the pathway 818 that the transmission of the audio data corresponding to the wave file 817 will follow, in other embodiments the ADF 809 may monitor one or more other pathways in addition to or in place of the pathway 818 of FIG. 10. As non-limiting examples, other pathways may include pathways transmitted audio data for system sounds follow or pathways transmitted audio data for MIDI files follow. As a further non-limiting example, if a MIDI file is the source of the audio data transmitted along the monitored pathway, it is likely that the pathway will pass through the MIDI out 815 of the audio component 804.

An audio component 810 can typically play sounds from many different sources such as a CD player, a DVD player, wave files, and MIDI files, as non-limiting examples. There are also many different techniques for playing sounds in a computer. For instance, “high level”, “mid-level”, or “low-level” functions as provided by the APIs 807 could be used.

The OS 806 may additionally include a mixer (not shown). The mixer mixes sound data from a number of applications prior to the data being sent to an audio component 804 and/or a MM device 810. In other words, if two applications choose to play wave files, the data representing the audio signals of the wave files will be mixed together by the mixer prior to being sent to the audio component 804/MM device 810. Similarly, data from different file types, e.g., wave and motion picture experts group (MPEG) 1, layer III (commonly known as “mp3”) data, can also be mixed by the mixer. The mixer is not shown for clarity.

In the specific example of a Windows OS 806, the Windows OS 806 includes several APIs 807 used to play sounds. For instance, a Media Control Interface (MCI) is typically part of a Windows Software Development Kit (SDK) and provides API functionality. Another Windows API is DirectX, including “DirectSound” functions. Yet another API is MMIO, Multimedia Input and Output. A wave file can be played using MCI, DirectSound, and MMIO (or combinations thereof). Note that the APIs listed above and the use of a Windows OS are by way of non-limiting examples.

Although the ADF 809 is shown in FIG. 10 as an independent program located in the MEM 802, in alternate embodiments the ADF 809 may be located anywhere in the electronic device 800 where the ADF 809 can monitor at least one pathway for the transmission of data representing an audio signal between at least one application and at least one sound device. As additional non-limiting examples, the ADF 809 may be located interposed between the OS 806 and the audio component 804/MM device(s) 810, within the audio component 804, within the application 805 (provided the application 805 is capable of monitoring audio signals), or as a separate entity that monitors the coupling between the OS 806 and audio component 804 (as opposed to the ADF 809 being literally interposed between the two).

Although illustrated in FIG. 10 as a separate entity from the OS 806, in other embodiments the ADF 809 may be a part of the OS 806. In such exemplary embodiments, the ADF 809 would remain independent of the APIs 807 (e.g., the ADF 809 would not be an API located within APIs 807) to ensure that all data representing audio signals could be detected and not merely that data that is transmitted in conjunction with the use an API from the APIs 807. In such exemplary embodiments, the ADF 809 may still utilize APIs 807 of the OS 806 to monitor other locations in the system, such as a wave out mix audio driver located in the audio drivers 808, as a non-limiting example.

Generally, various exemplary embodiments of the invention can be implemented in different mediums, such as software, hardware, logic, special purpose circuits or any combination thereof. As a non-limiting example, some aspects may be implemented in software which may be run on a computing device, while other aspects may be implemented in hardware.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. A computer program product comprising program instructions embodied on a tangible computer-readable medium, execution of the program instructions resulting in operations comprising:
monitoring at least one pathway between at least one application and a sound device in order to detect a presence of data that represents an audio signal; and
in response to detecting the presence of data, generating a visual notification corresponding to the audio signal.

2. The computer program product of claim 1, wherein the visual notification comprises a waveform of at least a portion of the audio signal.

3. The computer program product of claim 1, wherein the visual notification comprises a graphic representing the audio signal.

4. The computer program product of claim 1, wherein the visual notification comprises first information about the audio signal and wherein the first information comprises a sampling rate of the audio signal.

5. The computer program product of claim 1, wherein the visual notification comprises first information about the audio signal and wherein the first information comprises a file name corresponding to the audio signal.

6. The computer program product of claim 5, wherein the file name corresponding to the audio signal is determined based on a library comprising second information on known audio files.

7. The computer program product of claim 6, wherein the second information comprises audio signal information of the known audio files and names of the known audio files.

8. The computer program product of claim 1, wherein the program instructions operate independently of a preexisting accessibility application programming interface (API).

9. The computer program product of claim 1, wherein the program instructions operate independently of the at least one application utilizing a preexisting accessibility application programming interfaces (API).

10. The computer program product of claim 1, wherein monitoring at least one pathway comprises monitoring an output of an audio device driver.

11. The computer program product of claim 10, wherein the monitored output of the audio device driver comprises a wave out mix.

12. A method comprising:
monitoring at least one pathway between at least one application and a sound device in order to detect a presence of data that represents an audio signal; and
in response to detecting the presence of data, generating a visual notification corresponding to the audio signal.

13. The method of claim 12, wherein the visual notification comprises a waveform of at least a portion of the audio signal.

14. The method of claim 12, wherein the visual notification comprises a graphic representing the audio signal.

15. The method of claim 12, wherein the visual notification comprises first information about the audio signal and wherein the first information comprises a file name corresponding to the audio signal.

16. The method of claim 15, wherein the file name corresponding to the detected audio signal is determined based on a library comprising second information on known audio files.

17. The method of claim 12, wherein monitoring at least one pathway comprises monitoring an output of an audio device driver

18. The method of claim 17, wherein the monitored output of the audio device driver comprises a wave out mix.

19. An electronic device comprising:
at least one memory; and
at least one data processor coupled to the at least one memory, wherein the at least one data processor is operable to perform operations comprising:
monitoring at least one pathway between at least one application and a sound device in order to detect a presence of data that represents an audio signal; and
in response to detecting the presence of data, generating a visual notification corresponding to the audio signal.

20. The electronic device of claim 19, wherein the visual notification comprises an element in a systray of a taskbar.
